(19) United States
(12) Patent Application Publication
(10) Pub. No.: US 2001/0003348 A1
(43) Pub. Date: Jun. 14, 2001

(54) DOUBLE ANGLE ROTOSPRAY DISPENSER

(76) Inventor: PETER DUDANOWICZ, NEW BRITAIN, CT (US)

Correspondence Address: LOCTITE CORPORATION, LEGAL DEPARTMENT, 1001 TROUT BROOK CROSSING, ROCKY HILL, CT, 06067

(21) Appl. No.: 09/446,062

(22) PCT Filed: May 7, 1999
(86) PCT No.: PCT/US99/09918

§ 371 Date: None

(51) Int. Cl. B05B 17/04; B05B 3/00

(52) U.S. Cl. 239/7; 239/223; 239/224; 239/225.1; 239/231; 239/518

(57) ABSTRACT

A double angle rotospray dispenser including: (a) a rotatable shaft; and (b) a dispensing tip connected to a free end of the rotatable shaft. The dispensing tip includes: (i) a first angled surface extending outwardly from the shaft axis; (ii) a second opposing angled surface connected to the first angled surface and extending inwardly towards the shaft axis; and (iii) a terminal surface located at a bottom end of the dispensing tip, adjacent to the second opposing angled surface.

### BACKGROUND OF THE INVENTION

1. Field of the Invention

This invention relates to a double angle rotospray dispenser for dispensing a highly viscous material, such as an adhesive.

2. Brief Description of the Technology

It is oftentimes desirable to dispense a highly viscous material, such as an adhesive, into the inside of a small hole or bore. For example, most automobile engines are designed with freeze plugs which, in the event water freezes in the engine block, prevent the engine block from cracking by popping out from the engine block when the frozen water expands. The freeze plugs are provided in the engine block by drilling a small hole/bore into the block and inserting a plug member therein. In order to ensure that the freeze plugs do not become dislodged from the engine block (such as due to any incidental vibrations) a ring or band of adhesive is dispensed into the hole prior to insertion of the plug. It is imperative, however, that the adhesive be dispensed into the bore in a clean, precise fashion.

In the past, highly viscous materials have been dispensed into small holes/bores using, among other devices, a flat-bottom rotary dispensing tip, spinning at some predetermined rate of speed. An example of such a flat-bottom rotary dispensing tip is shown in FIG. 1. The highly viscous product is applied onto the flange portion of the rotating dispenser causing the product to be slung from the dispenser and onto an inner surface of the hole/bore by way of centrifugal force.

A problem associated with the use of these types of rotary dispensing tips is that the highly viscous product being dispensed has a tendency of accumulating on the underside of the tip and dispersing randomly within the bore.

Another disadvantage relates to a phenomenon known as “bridging” whereby the viscous product is dispensed onto the inner wall of the bore and does not release off the dispenser tip resulting in uneven application of product.

Accordingly, it would be desirable to provide a dispensing tip which does not present these known problems during application of the product.

### SUMMARY OF THE INVENTION

The present invention is directed to a double angle rotospray dispenser. The dispenser includes a rotatable shaft having a dispensing tip connected to a free end of the shaft. The dispensing tip includes a first angled surface extending outwardly from the shaft, a second opposing angled surface disposed onto the first angled surface and extending inwardly toward the shaft, and a terminal surface located at a bottom end of the dispensing tip, adjacent to the second opposing angle surface.

The present invention is also directed to a process for dispensing a viscous product onto an interior wall of a bore.

The process includes: (a) providing a double angle rotospray dispenser in accordance with the present invention, (b) inserting the dispenser into the bore, rotating the dispenser at a predetermined velocity, and (c) depositing the viscous product onto a first angled surface of the dispenser and dispensing the product onto the interior wall of the bore in the form of a thin band.

The invention will be more fully appreciated by a reading of the “Detailed Description of the Invention”, together with the figures.

### BRIEF DESCRIPTION OF THE DRAWINGS

FIG. 1 depicts an elevational view of a known flat-bottom rotary dispensing tip.

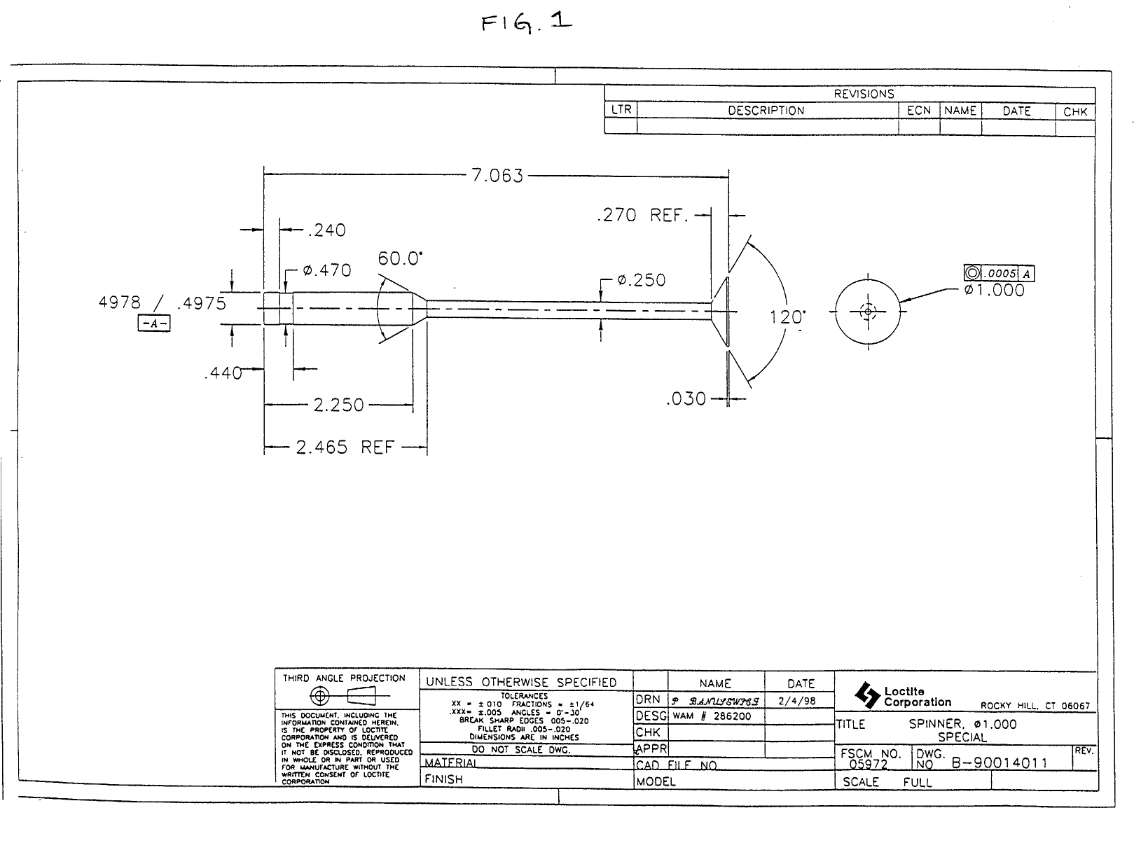

FIG. 2 depicts a double angle rotospray dispenser of the present invention in an elevational cross-sectional view.

FIG. 3 depicts in a cross-sectional view the dispenser of FIG. 2 disposed within a bore, onto the interior wall of which product may be dispensed.

### DETAILED DESCRIPTION OF THE INVENTION

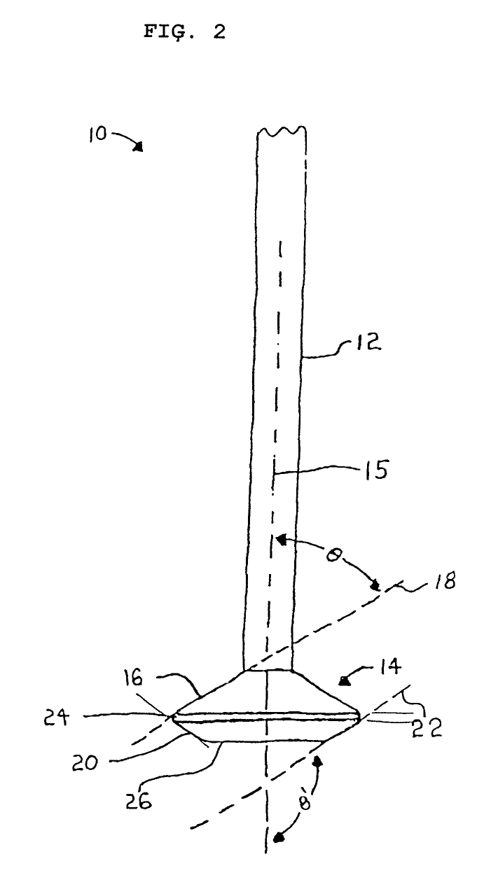

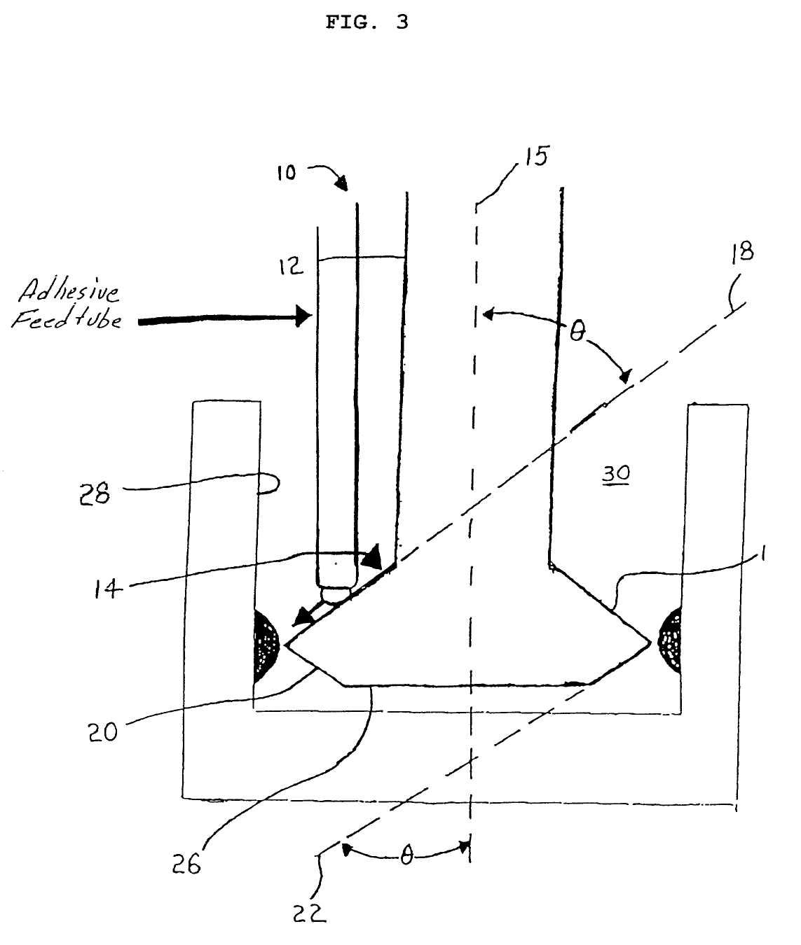

Referring to the figures, where like numerals indicate like elements throughout, there is shown in FIGS. 2 and 3 a double angle rotospray dispenser referred to generally by reference numeral 10. The dispenser 10 includes a rotatable shaft 12, which may be hollow or solid, having a dispensing tip 14 located at one end of the rotatable shaft 12. Located at the other end of the rotatable shaft 12 is a drive (not shown).

The dispensing tip 14 is comprised of a first angled surface 16 extending outwardly from a central longitudinal axis of rotation 15 of the shaft 12. The first angled surface 16 is arranged relative to shaft 12 such that a straight line 18 representing a plane of the first angled surface 16 forms an angle θ with central axis 15. Angle θ may range from about 10°to about 40°, such as about 30°.

A second opposing angled surface 20 disposed onto the first angled surface 16 is provided, where the second opposing angled surface 18 extends inwardly towards the shaft 12. Together, the first and second angled surfaces form a conical surface. The second angled surface 20 is arranged relative to shaft 12 such that a straight line 22 representing a plane of the second opposing angled surface 20 forms an angle θ′ with central axis 15. Angle θ′ may also range from about 10°to about 40°, such as about 30°.

According to one embodiment of the present invention (see FIG. 2), a planar surface 24 substantially parallel to the shaft 12 is interposed between the first angled surface 16 and the second opposing angled surface 18 in order to separate the two angled surfaces. The distance from the first angled surface to the second opposing angled surface, as measured transversely to the central axis 15, can range from about 0.005 inches to about 0.05 inches.

The dispensing tip 14 has a terminal surface 26 located at one end of the dispensing tip 14. The terminal surface 26 can be made to have any desired configuration. However, in order to facilitate maximum range of product dispensation within a bore 30, it is desirable for the terminal surface 26 to be either convex or planar so that the dispensing tip 14 can be inserted toward the bottom of the bore 30.

Product dispensing means 11, well known in the art, is provided to deposit product onto the first angled surface for dispensing onto an interior wall 28 of bore 30.

The rotatable shaft 12 is connected at one end to rotating or spinning means (not shown), an example of which is a drive, commonly known in the industry. The rotatable shaft 12 is rotated/spun by the drive, thereby causing product to be dispensed from that first surface onto an interior wall 28 of the bore 30 by way of centrifugal force.

The opposing angles θ and θ′ formed by the first angled surface and the second opposing angled surface force product being dispensed towards the point where lines 18 and 22 intersect (at the dispensing tip 24), thereby causing a thin band of product to be dispensed onto the interior wall 28 of bore 30. Product is thus not allowed to migrate towards the terminal surface 26 of the dispensing tip 14 in order to cause the previously outlined disadvantages. The dispenser 10 can be made of any rigid material such as, for example, stainless steel, aluminum, or a thermoplastic material.

In operation, the dispenser 10 is inserted into a bore 30 and suspended therein with its central axis 15 being coincident with a longitudinal axis of the bore 30. A product to be dispensed inside the bore, such as a highly viscous adhesive material, is deposited onto the first conical surface 16 of the dispensing tip 14. The shaft 12 is then rotated at a predetermined velocity causing product to be dispensed onto the interior wall 28 of the bore 30 by way of centrifugal force. The product will be dispensed onto the interior wall 28 in the form of a band. By displacing the dispensing tip along the axis of the bore, the band width of dispensed product can be varied by either traversing the bore 30 during a single application of product or by making several discreet applications in different axial locations within the bore 30.

According to a method of the present invention, a double angle rotospray dispenser in accordance with the present invention is provided. The dispenser is inserted within the bore and then caused to rotate at a predetermined viscosity. Product is then dispensed onto the dispensing tip of the dispenser and then applied onto an interior wall of a bore, in the form of a band, by way of centrifugal force.

From the foregoing description, it can be seen that the present invention provides an easily manufactured and superior performing dispenser. It is understood that the invention is not limited to the particular embodiment disclosed, but is intended to include modifications thereto. It will be recognized that although certain modifications have been suggested, other changes could be made to the above-described invention without departing from its spirit or scope which is defined by the claims.

What is claimed is:

1. A double angle rotospray dispenser comprising:
(a) a rotatable shaft; and
(b) a dispensing tip connected to one end of the rotatable shaft, the dispensing tip comprising:
(i) a first angled surface extending outwardly from the shaft;
(ii) a second opposing angled surface connected to the first angled surface and extending inwardly toward the shaft; and
(iii) a terminal surface located at a bottom end of the dispensing tip, adjacent to the second opposing angled surface.

2. The dispenser of claim 1, wherein the rotatable shaft has a central longitudinal axis.

3. The dispenser of claim 2, wherein the first angled surface and central axis form an angle θ ranging from about 10°to about 40°.

4. The dispenser of claim 3, wherein the first angled surface and the central axis of the shaft form an angle θ of about 30°.

5. The dispenser of claim 2, wherein the second opposing angled surface and central axis of the shaft form an angle θ ranging from about 10°to about 40°.

6. The dispenser of claim 5, wherein the second opposing angled surface and the central axis of the shaft form an angle θ′ of about 30°.

7. The dispenser of claim 1, further comprising a planar surface interposed between, and connecting, the first angled surface and the second opposing angled surface.

8. The dispenser of claim 7, wherein the planar surface has a height, as measured along the central axis of the shaft, from about 0.005 to about 0.05 inches.

9. The dispenser of claim 1, wherein drive means are provided for rotating the shaft at varying speeds.

10. The dispenser of claim 1, wherein product dispensing means are provided for depositing product onto the first angled surface of the dispensing tip.

11. A process for dispensing a viscous product onto an interior wall of a bore comprising:
(a) providing a double angle rotospray dispenser which includes:
(i) a rotatable shaft; and
(ii) a dispensing tip connected to one end of the rotatable shaft, the dispensing tip comprising:
a first angled surface extending outwardly from shaft;
a second opposing angled surface connected to the first angled surface and extending inwardly towards the shaft; and
a terminal surface located at a bottom end of the dispensing tip, adjacent to the second opposing angled surface;
(b) inserting the dispenser into the bore;
(c) rotating the dispenser at a predetermined velocity; and
(d) depositing the viscous product onto the first angled surface of the dispensing tip.
